(19) United States
(12) Patent Application Publication
(10) Pub. No.: US 2026/0286925 A1
(43) Pub. Date: Sep. 24, 2026

(54) PREIGNITION DETECTION FOR HYDROGEN COMBUSTION ENGINES

(71) Applicant: Cummins Inc., Columbus, IN (US)

(72) Inventor: Sachin Joshi, Columbus, IN (US)

(21) Appl. No.: 19/476,770

(22) PCT Filed: Apr. 23, 2024
(86) PCT No.: PCT/US2024/025753

§ 371 Date: Oct. 20, 2025

Related U.S. Application Data
(60) Provisional application No. 63/498,285, filed on Apr. 26, 2023.

(51) Int. Cl. F02P 17/12; F02P 3/05; F02P 3/08

(52) U.S. Cl. CPC F02P 17/12; F02P 3/05; F02P 3/0807; F02P 2017/121

(57) ABSTRACT

A method of controlling a spark-ignited combustion engine to combust hydrogen includes operating an ignition system including a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil. During the operating after controlling the switch to provide the primary current and before a spark has been generated by the spark plug, the method senses a make voltage of the secondary circuit, diagnosing a preignition event based at least in part on the make voltage, and in response to the diagnosing at least one of modifying operation of the spark-ignited combustion engine and providing an operator perceptible output indicating the preignition event.

### CROSS-REFERENCE TO RELATED APPLICATIONS

The present application claims the benefit of and priority to U.S. Application No. 63/498,285, filed Apr. 26, 2023, and the same is hereby incorporated by reference.

### TECHNICAL FIELD

The present application relates to apparatuses, methods, systems, and techniques for preignition detection for internal combustion engines using hydrogen or a mixture of hydrogen and other hydrocarbons.

### BACKGROUND

Internal combustion engines may experience preignition events in which a combustion air-fuel mixture ignites earlier than intended, for example, during a compression stroke at a point earlier than a spark or ignition time. Various attempts have been made to detect preignition. Existing approaches suffer from a number of disadvantages and shortcomings including unsuitability for detecting preignition of hydrogen as well as those respecting accuracy, complexity, cost, efficacy, reliability, robustness, and others. There remains a significant need for the unique apparatuses, methods, systems, and techniques of the present disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique apparatuses for preignition detection for hydrogen combustion engines. Some embodiments include unique methods for preignition detection for hydrogen combustion engines. Some embodiments include unique systems for preignition detection for hydrogen combustion engines. Some embodiments include unique techniques for preignition detection for hydrogen combustion engines. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example powertrain system.

FIG. 2 is a flow diagram illustrating certain aspects of an example ignition system.

FIG. 3 is a flow diagram illustrating certain aspects of an example ignition system.

FIG. 4 is a flow diagram illustrating certain aspects of example controls.

FIG. 5 is a graph illustrating certain aspects of example preignition diagnostic techniques.

FIG. 6 is a graph illustrating certain aspects of example preignition diagnostic techniques.

FIG. 7 is a graph illustrating certain aspects of example preignition diagnostic techniques.

FIG. 8 is a graph illustrating certain aspects of example preignition diagnostic techniques.

FIG. 9 is a schematic diagram illustrating certain aspects of example controls.

FIG. 10 is a schematic diagram illustrating certain aspects of example controls.

FIGS. 11-15 are graphs illustrating certain example engine operating parameters.

### DETAILED DESCRIPTION OF EXAMPLE EMBODIMENTS

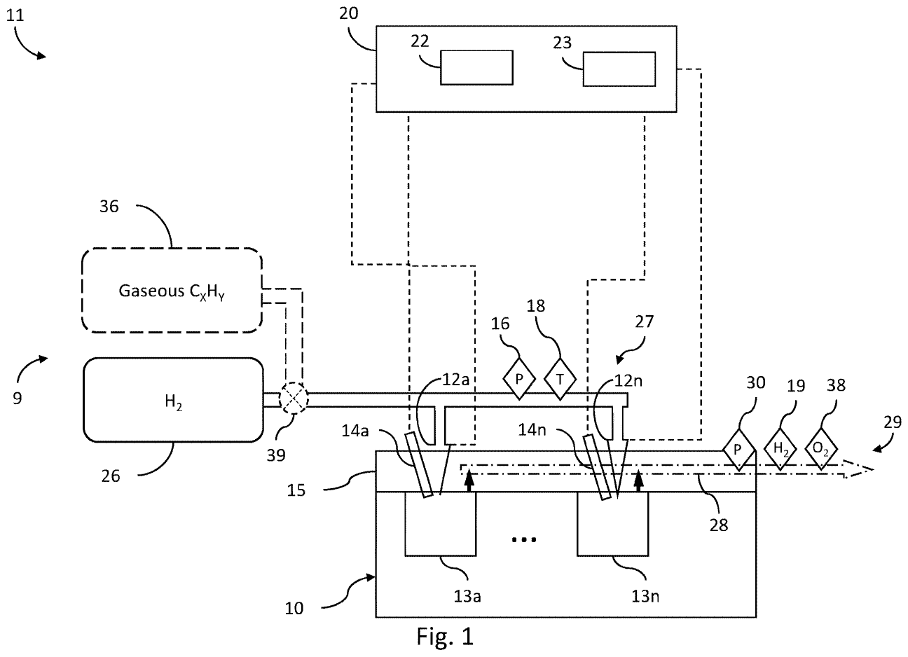

With reference to FIG. 1, there is illustrated an example powertrain system 11 (also referred to herein as system 11) comprising a fueling system 9 and an engine 10. Fueling system 9 is adapted and configured to supply gaseous hydrogen for combustion to engine 10. In some embodiments, fueling system 9 may be additionally adapted and configured to supply gaseous hydrocarbon (CₓH_{y}) for combustion to engine 10 in combination with gaseous hydrogen. Engine 10 comprises combustion chambers 13 (also referred to as cylinders) of a reciprocating piston-in-cylinder type which are configured to generate mechanical power from the combustion of gaseous fuel supplied by fuel injectors 12a, 12n. System 11 may be provided in a number of forms including as a prime mover system (or component of a prime mover system) of vehicle, a genset, other power-load system.

Fuel injectors 12a, 12n are in fluid communication with respective combustion chambers 13a, 13n of the engine 10 and are structured to inject gaseous fuel which is provided to their respective combustion chambers 13a, 13n. In the illustrated embodiment, fuel injectors 12 are configured and provided as port fuel injectors configured to inject fuel directly into respective ports of intake manifold 15 leading to respective combustion chambers 13 of engine 10. Other embodiments may include other types and configurations of injectors such as direct fuel injectors configured to inject fuel directly into respective combustion chambers of engine 10. In the illustrated embodiment, two fuel injectors 12a, 12n and two combustion chambers 13a, 13n are depicted, it being appreciated that engine 10 may include fewer or greater numbers of fuel injectors and combustion chambers arranged and configured in a variety of manners.

In the illustrated embodiment, fueling system 9 includes a hydrogen fuel supply 26 and a gaseous fuel injection system 27. Injection system 17 may include one or more rails and one or more sets of injectors (e.g., injectors 12a, 12n or other injectors) operatively coupled with and supplied with gaseous fuel from a respective one of the one or more rails. The one or more rails are, in turn, configured to receive pressurized fuel from hydrogen fuel supply 26.

In some embodiments, fueling system 9 may include a gaseous hydrocarbon (e.g., natural gas, wellhead gas, biogas, or other gaseous hydrocarbons) fuel supply 36 which is configured to supply gaseous hydrocarbon fuel for combustion to engine 10. In the illustrated example gaseous hydrocarbon fuel supply 36 is adapted to introduce hydrogen and gaseous hydrocarbon fuel into the gaseous fuel injection system via a valve and mixer system 39 which can selectably vary the relative proportion of hydrogen and gaseous hydrocarbon provided for combustion by engine 10. In other embodiments, gaseous hydrocarbon fuel supply 36 may be provided with separate rails and injectors which may be adapted to inject gaseous hydrocarbon fuel into a respective ports or directly into respective cylinders separately from the rails and injectors that supply hydrogen for combustion by engine 10.

In some embodiments, fueling system 9 may include additional elements such as a compressor configured to compress gaseous fuel received from the fuel tank supply compressed gaseous fuel to the one or more rails, and/or and accumulator as well as electronically controllable valves configured to control supply of gaseous fuel to and from the accumulator and/or the one or more rails.

System 11 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 11. For example, the sensors may include a pressure sensor 16 and a temperature sensor 18. The pressure sensor 16 is in communication with the common fuel rail 14 and structured to communicate a measurement of the pressure within the common fuel rail 14 to the ECS 20. The temperature sensor 18 is in communication with the common fuel rail 14 and structured to communicate a measurement of the temperature within the common fuel rail 14 to the ECS 20.

System 11 further includes exhaust system 29 including exhaust manifold 28 various conduits and aftertreatment components and systems as will occur to one of skill in the art with the benefit and insight of the present disclosure. In the illustrated example, exhaust system 29 includes a pressure sensor 30 in operative communication with ECS 20 and configured and operable to sense exhaust pressure and provide one or more signals indicative thereof to ECS 20. Pressure sensor 30 may be configured and provided, for example, as an exhaust manifold pressure (EMP) configured to sense pressure in or associated with exhaust manifold 28 or as another sensor configuration or type as will occur to one of skill in the art with the benefit and insight of the present disclosure. Output of pressure sensor 30 provided to ECS 20 may be utilized for control, diagnostic, prognostic, and other purposes. As further described herein, such purposes may include detection or diagnosis of preignition events (including early preignition events), and discrimination between preignition, misfire, and normal or desired combustion events.

In the illustrated example, exhaust system 29 includes oxygen (O₂) sensor 38 in operative communication with ECS 20 and configured and operable to sense a one or more characteristics indicative of a concentration of oxygen of exhaust output by engine 10 and to provide one or more signals indicative thereof to ECS 20. Oxygen sensor 38 may be configured and provided, for example, as a lambda sensor or as another sensor configuration or type as will occur to one of skill in the art with the benefit and insight of the present disclosure. Output of oxygen sensor 38 provided to ECS 20 may be utilized for control, diagnostic, prognostic, and other purposes as further described herein. As further described herein, such purposes may include detection or diagnosis of preignition events (including early preignition events), and discrimination between preignition, misfire, and normal or desired combustion events.

In the illustrated example, exhaust system 29 includes hydrogen (H₂) sensor 19 in communication with ECS 20 and configured and operable to sense a one or more characteristics indicative of a concentration of hydrogen of exhaust output by engine 10 and to provide one or more signals indicative thereof to ECS 20. Hydrogen sensor 19 may be configured and provided, for example as an optical sensor, electrochemical sensor, thin film sensor, thick film sensor, or as another sensor configuration or type as will occur to one of skill in the art with the benefit and insight of the present disclosure. Output of hydrogen sensor 19 provided to ECS 20 may be utilized for control, diagnostic, prognostic, and other purposes as further described herein. As further described herein, such purposes may include detection or diagnosis of preignition events (including early preignition events), and discrimination between preignition, misfire, and normal or desired combustion events.

As will be appreciated by the description that follows, the techniques described herein relating to fuel injector or fuel injection parameters can be implemented in ECS 20, which may include one or more controllers for controlling different aspects of the system 11. In one form ECS 20 comprises one or more electronic control units (ECU) such as an engine control unit or engine control module. ECS 20 may be comprised of digital circuitry, analog circuitry, or a hybrid combination of both of these types. Also, ECS 20 may be programmable, an integrated state machine, or a hybrid combination thereof. ECS 20 may include one or more Arithmetic Logic Units (ALUs), Central Processing Units (CPUs), memories, limiters, conditioners, filters, format converters, or the like which are not shown to preserve clarity. In one form, ECS 20 is of a programmable variety that executes algorithms and processes data in accordance with operating logic that is defined by programming instructions (such as software or firmware). Alternatively or additionally, operating logic for ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of system 11. As used herein, the term sensors may include any suitable hardware and/or software used to sense or estimate any engine system parameter and/or various combinations of such parameters either directly or indirectly.

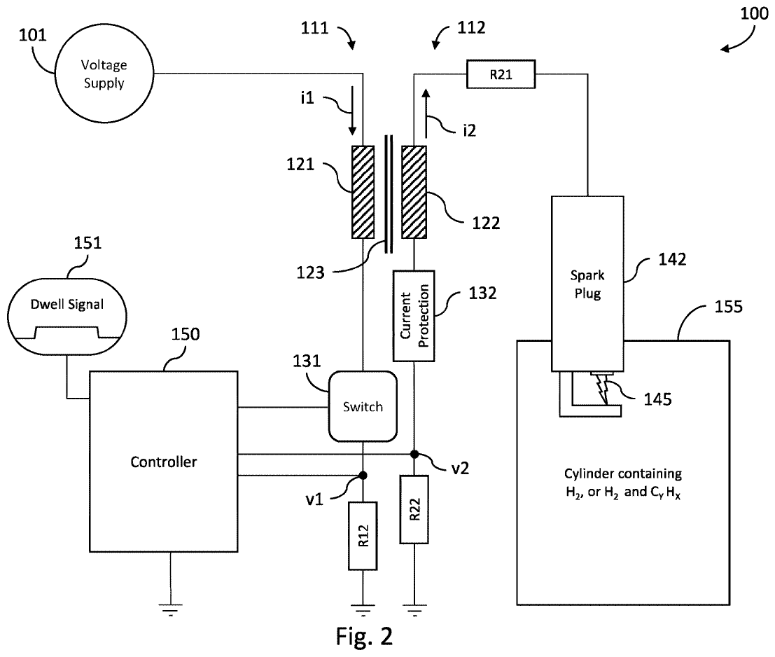

With reference to FIG. 2, there is illustrated an ignition system 100 (also referred to herein as system 100) which may be provided and implemented in a powertrain system such as system 11. In the illustrated example, system 100 is configured as an inductive ignition system. It shall be appreciated that other embodiments may utilize other types of ignition systems including, for example, a capacitive discharge ignition system.

System 100 includes a primary circuit 111 comprising a first coil 121 operatively coupled with a voltage supply 101 and a switch 131 controllable to regulate a primary current il in the primary circuit 111. In the illustrated example, switch 131 is operatively coupled with and adapted to be controlled by controller 150 to regulate a primary current il in the primary circuit 111 in response to a dwell signal 151 provided as input to the controller 150.

Primary circuit 111 may further include a resistor R12 coupled with the switch 131 and with ground. The switch 131 may be provided in a number of forms including, for example, an insulated gate bipolar transistor (IGBT), a power metal oxide silicon field effect transistor (MOSFET) such as a silicon carbide (SiC) MOSFET, or other types of switching devices as will occur to one of skill in the art with the benefit and insight of the present disclosure.

System 100 includes a secondary circuit 112 comprising a second coil 122 operatively coupled with a spark plug 142. Secondary circuit 112 may further include one or more current protection device(s) 132, for example, one or more diodes. Secondary circuit 112 may also include a resistor R21 coupled with the second coil 122 and with the spark plug 142, and a resistor R22 coupled with the current protection device(s) 132 and with ground.

A core 123 magnetically couples the first coil 121 and the second coil 122 and transfers energy from the first coil 121 to the second coil 122 during operation of ignition system 100. For example, during operation, controller 150 may close or otherwise operate switch 131 to cause the primary current il to flow to the first coil 121 and may thereafter open switch 131 to interrupt the path to ground of the primary current il. The primary current il induces a magnetic field in core 123 by which energy is transferred the second coil 122. As a result a secondary current i2 is induced in the secondary circuit and flows to spark plug 142. In response, when the spark plug 142 becomes sufficient charged, a spark 145 is generated in combustion cylinder 155 to ignite a hydrogen-based fuel such as gaseous hydrogen (H₂) or a mixture or combination of H₂ and gaseous hydrocarbon (C_{X}H_{Y}).

Controller 150 may be provided in a number of forms including, for example, as a microprocessor-based or other integrated circuit-based electronic controller. Controller 150 may be provided as a component of an electronic control system such as ECS 20 or another electronic control system, and may be provided as a stand-alone or discrete control component or implemented in combination with other control components in a variety of manners as will occur to one of skill in the art with the benefit and insight of the present disclosure.

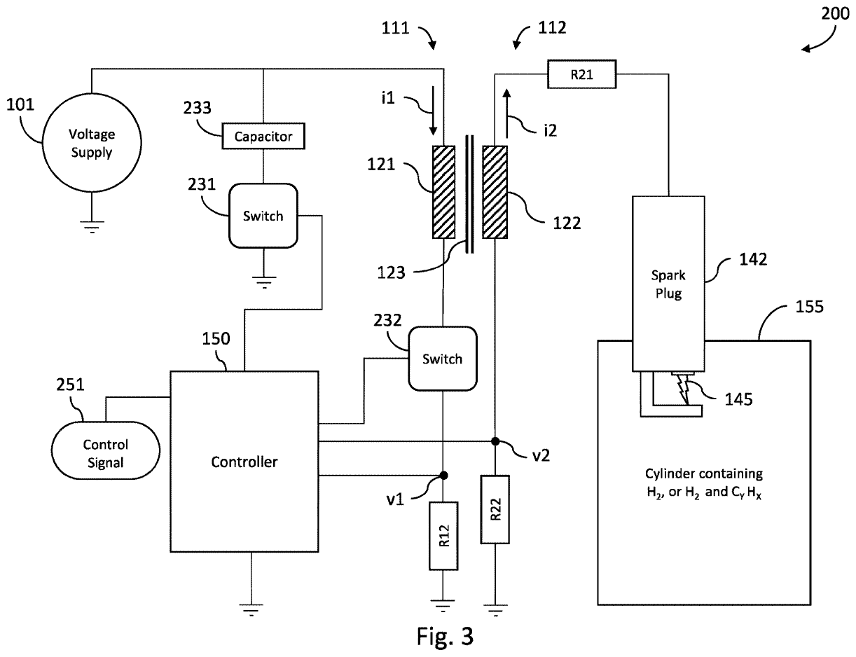

With reference to FIG. 3, there is illustrated an ignition system 200 (also referred to herein as system 200) which may be provided and implemented in a powertrain system such as system 11. In the illustrated example, system 200 is configured as a capacitive discharge ignition system. It shall be appreciated that other embodiments may utilize other types of ignition systems including, for example, inductive ignition systems.

System 200 includes a number of elements which are the same as or substantially similar to the elements described above in connection with system 200. In FIG. 3, such elements are denoted with the same reference numerals utilized in connection with system 200 it being appreciated that such elements may vary among the several embodiments disclosed herein mutatis mutandis.

System 200 also varies from system 100 in a number of respects. For example, during, controller 150 may close or otherwise operate switch 231 one or more control signals 251 and open or otherwise operate switch 232 to cause voltage supply 101 to charge capacitor 233 in response to the one or more control signals 251. Thereafter, controller 150 may open or otherwise operate switch 231 and close or otherwise operate switch 232 to cause capacitor 233 to discharge the primary current il to flow to the first coil 121.

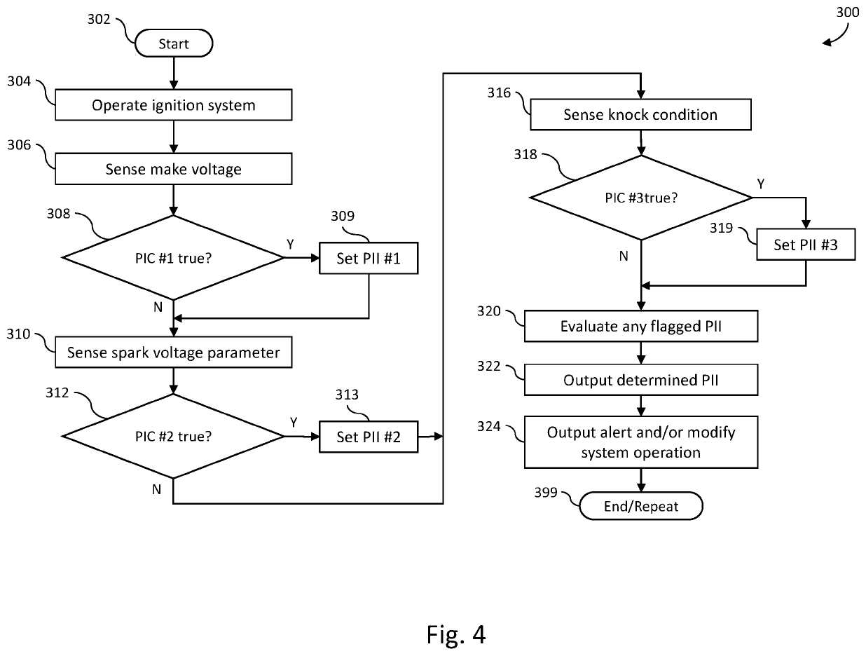

With reference to FIG. 4, there is illustrated an example process 300 for operating an electronic control system (e.g., ECS 20 or another electronic control system), in operative communication with a fueling system (e.g., fueling system 9 or another fueling system). Process 300 may be implemented in and performed by one or more components of an electronic control system such as one or more electronic control units (e.g., ECU 22 and/or other electronic control units) and/or by other electronic control system components.

Process 300 begins at start operation 302 and proceeds to operation 304 which operates an ignition system such as system 100 or another ignition system to cause one or more spark plugs to generate a spark. Operation 304 may, for example, follow the same or a substantially similar ignition operation process as described in connection with system 100. For example, a controller may close or otherwise operate a switch to cause a primary current to flow to a first coil and may thereafter open switch to interrupt a path to ground of the primary current. The primary current may induce a magnetic field in a core by which energy is transferred a second coil. As a result a secondary current may be induced in a secondary circuit and flows to spark plug. In response, when the spark plug becomes sufficient charged, a spark is generated in combustion cylinder 155 to ignite a hydrogen-based fuel such as gaseous hydrogen (H₂) or a mixture or combination of H₂ and gaseous hydrocarbon (CₓH_{y}).

From operation 304, process 300 proceeds operation 306 which senses a make voltage. It shall be appreciated that a make voltage according to the present disclosure refers to a voltage of a secondary circuit of an ignition system, such as secondary circuit 112 of system 100, which occurs during operation of an ignition after controlling a switch or other control component to provide a primary current in a primary circuit such as primary circuit 111 and before a spark has been generated by a spark plug coupled with a secondary circuit such as secondary circuit 112 and may also be referred to as a pre-spark voltage. The sensing of a make voltage may be performed by controller such as controller 150 which is configured to sense voltage v2 at a node of secondary circuit 112 intermediate current protection device(s) 132 and resistor R22. It shall be appreciated that resistor R22 may be provided in parallel with one or more capacitors, diodes, or other circuit elements to facilitate sensing of voltage v2. In other embodiments, a make voltage may be sensed at other nodes of the secondary circuit 112 including, without limitation, nodes at or intermediate second coil 122 and spark plug 142 or other nodes of secondary circuit 112.

The sensing of a make voltage may occur during operation of an ignition system such as system 100 after controlling a switch to provide a primary current in a primary circuit and before a spark has been generated by the spark plug. The sensing of a make voltage may comprise sensing a voltage of a secondary circuit. In the context of system 100, for example controller 150 may sense a make voltage at the node of voltage v2 after control switch 131 to provide a primary current il in primary circuit 111 and before a spark has been generated by spark plug 142.

From operation 306, process 300 proceeds to conditional 308 which evaluates whether a first preignition criterion (PIC #1) is true. If conditional 308 evaluates negative, process 300 proceeds to operation 310. If condition 308 evaluates affirmative, process 300 proceeds to operation 309 which diagnoses a first potential preignition indication (PII #1). It shall be appreciated that terms such as diagnose, diagnoses, diagnosing or other grammatical variants or permutations thereof refer to a number of control structures or process operations including those which perform or are adapted, configured or structured to perform acts of determining, flagging, identifying, and/or setting, either as a final diagnosis or a possibility for further or future evaluation, as well as such other acts as would be understood by one of skill in the art to comprise an act of diagnosing, in whole or in part.

Operation 309 may diagnose PII #1 using a number of techniques. In some embodiments, operation 309 may diagnose a preignition event based at least in part on a sensed make voltage by evaluating the make voltage relative to a threshold. In some embodiments, operation 309 may diagnose a preignition event based at least in part on integrating the make voltage and evaluating a value resulting from the integrating. In some embodiments, operation 309 may diagnose a preignition event using techniques which comprise diagnosing severity of the preignition based at least in part on the make voltage.

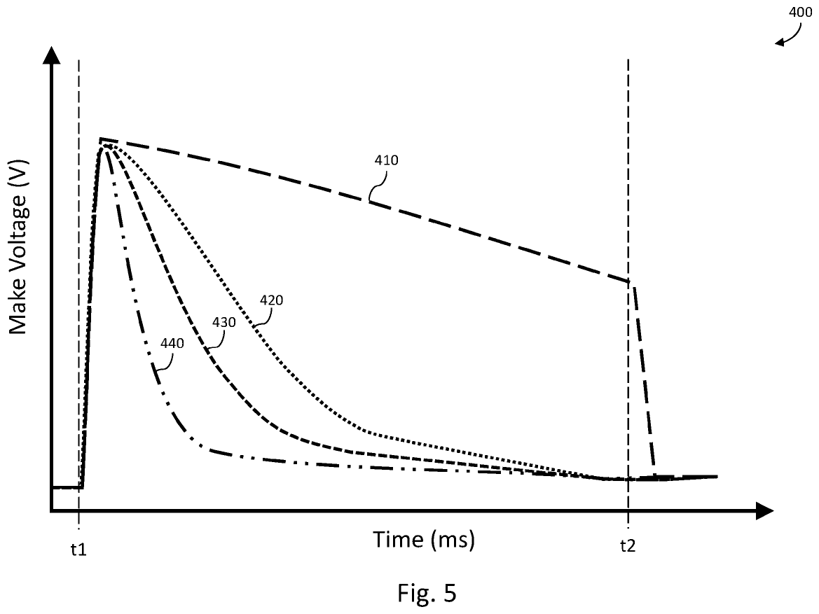

FIG. 5 depicts a graph 400 illustrating certain aspects of example preignition diagnostic techniques which may be utilized in connection with operation 309 or other preignition diagnostics. Graph 400 depicts make voltage on its vertical or y-axis as a function of time on its horizontal or x-axis. Time t1 indicates a time at which a switch is closed or otherwise controlled to provide a primary current in a primary circuit. Time t2 indicates a time at which the switch is opened or otherwise controlled to interrupt a path to ground of the primary current in the primary circuit. The time between time t1 and time d2 may be controlled with a dwell time signal provided to a controller such as dwell signal 151 and controller 150.

Curve 410 depicts a first make voltage at a node of a secondary circuit in the absence of a first preignition event. In the illustrated example, the first make voltage may be sensed at a node intermediate second coil 122 and spark plug 142. In other embodiments, the first make voltage may be sensed at another node of secondary circuit 112 such as node v2. Curve 420 depicts a second make voltage at a node of a secondary circuit such as node v2 of secondary circuit 112 in the presence of a second preignition event of greater magnitude and/or duration of the first preignition event. Curve 430 depicts a third make voltage at a node of a secondary circuit such as node v2 of secondary circuit 112 in the presence of a third preignition event of greater magnitude and/or duration of the second preignition event. Curve 440 depicts a fourth make voltage at a node of a secondary circuit such as node v2 of secondary circuit 112 in the presence of a fourth preignition event of greater magnitude and/or duration of the third preignition event.

Operation 309 may evaluate a sensed make voltage relative to one or more standards, thresholds or values established for a make voltage empirically or by a physics based model or calculation. The evaluation may utilize any one or more the aforementioned techniques as well as other techniques as will occur to one of skill in the art with the benefit and insight of the present disclosure. In some embodiments, a sensed make voltage may be integrated and the resulting value may be compared to a predetermined value which may be a fixed value or a parameter adjusted over time, for example, a running average of sensed make voltages. Such embodiments may account for variation resulting from changes in the underlying system being sensed. The resulting value may also be compared to a number of thresholds, values and/or additional or alterative criteria to establish a magnitude or severity of a diagnosed preignition event.

From operation 309, process 300 proceeds to operation 310 which senses a spark voltage parameter. The spark voltage parameter may be a directly detected spark voltage magnitude or a correlated value such as a spark duration, such as a duration measured from the time of start of the spark current rise in the secondary side to the time of the fall of the spark current below a threshold. It shall be appreciated that some spark voltage parameters may be particularly well suited for particular types of ignition systems. For example, a correlated value such as a spark duration may be particularly suited for an inductive or inductor based ignition system such as system 100 and a directly detected spark voltage magnitude may be particularly suited for a capacitive or capacitor based ignition system or circuit.

From operation 310, process 300 proceeds to conditional 312 which evaluates whether a second preignition criterion (PIC #2) is true. If conditional 312 evaluates negative, process 300 proceeds to conditional 316. If condition 312 evaluates affirmative, process 300 proceeds to operation 313 which may diagnose a second potential preignition indication (PII #2).

Operation 313 may diagnose PII #2 using a number of techniques. In some embodiments, operation 313 may diagnose a preignition event based at least in part on the spark voltage parameter.

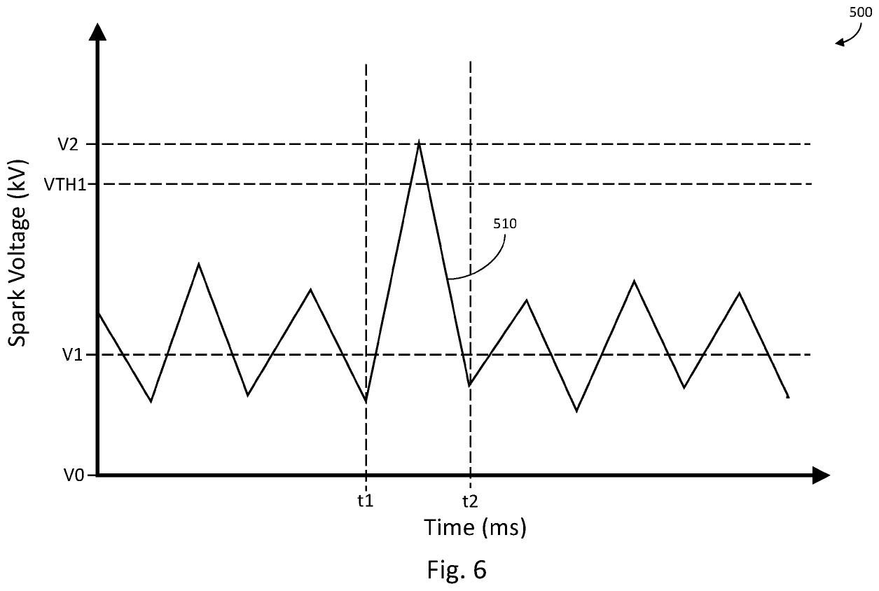

FIG. 6 depicts a graph 500 illustrating certain aspects of example preignition diagnostic techniques which may be utilized in connection with operation 313 or other preignition diagnostics. Graph 500 depicts spark voltage as a function of time. Times t1 and t2 indicates a given engine cycle.

Curve 510 depicts a first spark voltage at a node of a secondary circuit such as node v2 of secondary circuit 112 in the presence of a preignition event. Operation 313 may evaluate a sensed spark voltage relative to one or more standards, thresholds or values established for the spark voltage empirically or by a physics based model or calculation. The evaluation may utilize any one or more the aforementioned techniques as well as other techniques as will occur to one of skill in the art with the benefit and insight of the present disclosure. In some embodiments, a sensed spark voltage peak such as V2 may be evaluated relative to a threshold such as threshold VTH1 and may diagnose PII #2 if the threshold is exceeded. In some embodiments, and averaged or integrated spark voltage may be evaluated relative to another threshold or standard. The spark voltage peak, average, or integral sum may also be compared to a number of additional or alterative thresholds or criteria to establish a magnitude or severity of a diagnosed preignition event.

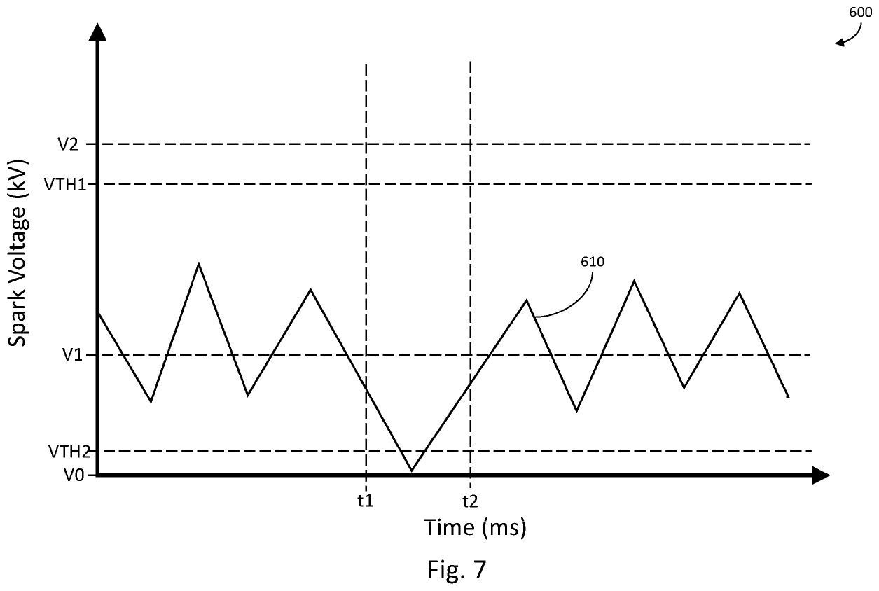

FIG. 7 depicts a graph 600 illustrating certain aspects of example preignition diagnostic techniques which may be utilized in connection with operation 313 or other preignition diagnostics. Graph 600 depicts spark voltage as a function of time. Times t1 and t2 indicates a given engine cycle.

Curve 610 depicts a first spark voltage at a node of a secondary circuit such as node v2 of secondary circuit 112 in the presence of a third preignition event. Operation 313 may evaluate a sensed spark voltage relative to one or more standards, thresholds or values established for the spark voltage empirically or by a physics based model or calculation. The evaluation may utilize any one or more the aforementioned techniques as well as other techniques as will occur to one of skill in the art with the benefit and insight of the present disclosure. In some embodiments, a sensed spark voltage minimum such as V0 may be evaluated relative to a threshold such as threshold VTH2 and may diagnose PII #2 if the threshold is exceeded. In some embodiments, and averaged or integrated spark voltage may be evaluated relative to another threshold or standard. The spark voltage peak, average, or integral sum may also be compared to a number of additional or alterative thresholds or criteria to establish a magnitude or severity of a diagnosed preignition event. It shall also be appreciated that threshold VTH1 and VTH2 may be used to distinguish between severities of a preignition, since, for example, a preignition event of sufficient magnitude may prevent sparking altogether such as in the example of FIG. 7.

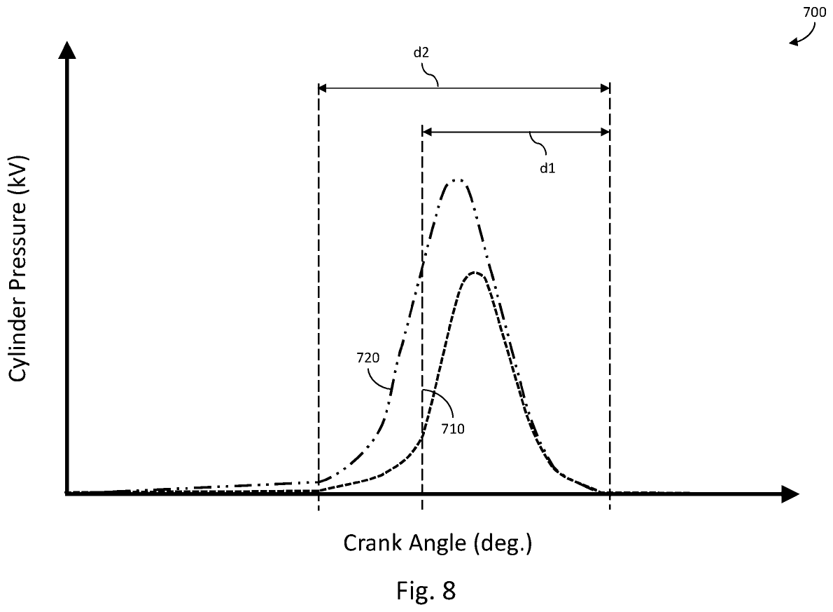

FIG. 8 depicts a graph 700 illustrating certain aspects of example preignition diagnostic techniques which may be utilized in connection with operation 313 or other preignition diagnostics. Graph 700 depicts cylinder pressure as a function of crank angle. Curve 710 depicts a pressure curve indicating combustion duration d1 in the absence of a preignition event. Curve 720 depicts a pressure curve indicating a spark duration d2 in the presence of a preignition event. Combustion durations such as duration d1 and duration d2 may be detected by a sensor such as a cylinder pressure sensor, an ion sensor or various other sensors as will occur to one of skill in the art with the benefit and insight of the present disclosure.

Operation 313 may evaluate a sensed spark duration and may compare the sensed spark duration relative to one or more standards, thresholds or values established for the spark voltage empirically or by a physics based model or calculation. The evaluation may utilize any one or more the aforementioned techniques as well as other techniques as will occur to one of skill in the art with the benefit and insight of the present disclosure. In some embodiments, a sensed spark duration may be evaluated relative to a threshold and may diagnose PII #2 if the threshold is exceeded. In some embodiments, and averaged or integrated spark duration may be evaluated relative to another threshold or standard. The spark duration may also be compared to a number of additional or alterative thresholds or criteria to establish a magnitude or severity of a diagnosed preignition event.

From conditional 312 or operation 313, process 300 proceeds to operation 316 which senses a knock condition, for example, using a knock sensor. From operation 316, process 300 proceeds to conditional 318 which evaluates a third preignition criterion (PIC #3) is true. Conditional 318 may utilize a number of techniques for diagnosing a preignition condition. In some embodiments conditional 318 may evaluate whether a knock sensor output indicating a knock event is preceded by a preignition indication such as PII #1 or PII #2 and may diagnose preignition on that basis.

If condition 318 evaluates negative, process 300 proceeds to operation 320. If condition 318 evaluates affirmative, process 300 proceeds to operation 319 which may diagnose a third potential preignition indication (PII #3). From operation 319, process 300 proceeds to operation 320.

Operation 320 evaluates any diagnose potential preignition indications which may have been set (e.g., one or more of PII #1, PII #2, PII #3, PII #4). For example, the presence or absence of one or more potential preignition indications may be used to characterize a severity or magnitude of preignition. Additionally or alternatively, the evaluations performed in connection with one or more of the individual potential preignition conditions may be3 used to characterize a severity or magnitude of preignition. Additionally or alternatively, the presence of absence of two or more preignition indications may be utilized to validate or determine error in a preignition diagnosis.

It shall be appreciated that some embodiments may utilize only certain ones of the aforementioned techniques. Some embodiments, may evaluate a single preignition condition (e.g., only one of PIC #1, PIC #2, and PIC #3) and may diagnose only a single preignition indication (e.g., only one of PIC #1, PIC #2, and PIC #3). Some embodiments, may evaluate two preignition conditions (e.g., any two of PIC #1, PIC #2, and PIC #3) and may diagnose only a single preignition indication (e.g., any two of PIC #1, PIC #2, and PIC #3). Some embodiments, may evaluate three preignition conditions (e.g., all of PIC #1, PIC #2, and PIC #3) and may diagnose only a single preignition indication (e.g., all of PIC #1, PIC #2, and PIC #3). Some embodiments may evaluate additional or alternative preignition conditions and may diagnose additional or alternative preignition indication.

From operation 320, process 300 proceeds to operation 322 which outputs any determined preignition indications. From operation 322, process 300 proceeds operation 324 which may output an alert, modify system operation, or both. In some embodiments operation 324 may modify operation of a spark-ignited hydrogen combustion engine, for example, by derating engine operation, entering a skip-fire engine operating mode, shutting off fuel for a particular cylinder, decreasing fueling for particular cylinder or a nearby cylinder to reduce heat generated by combustion, increasing a coolant flow rate, decreasing coolant temperature by operating one or more fans and/or heat exchangers, and/or other system operation modifications as will occur to one of skill in the art with the benefit and insight of the present disclosure. In some embodiments operation 324 may provide an operator perceptible output indicating a preignition event in a hydrogen combustion engine. From operation 324, process 300 proceeds to operation 399 where process 300 may end or repeat.

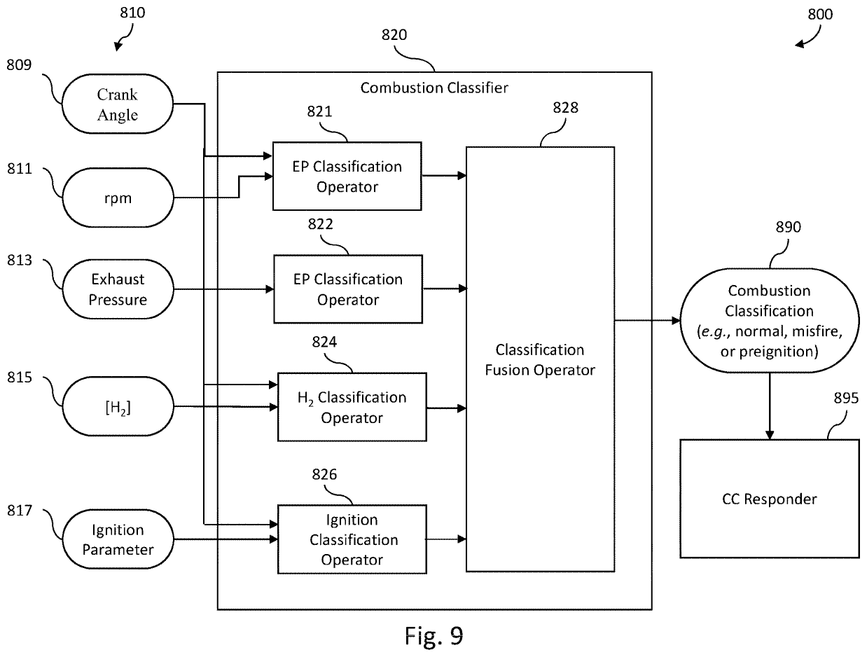

With reference to FIG. 9, there are illustrated example controls 800 which may be implemented in and executed by an electronic control system (e.g., ECS 20 or another electronic control system), in operative communication with a powertrain system (e.g., system 11 or another powertrain system). Controls 800 may be implemented in and performed by one or more components of an electronic control system such as one or more electronic control units (e.g., ECU 22 and/or other electronic control units) and/or by other electronic control system components.

Controls 800 include a combustion classifier 820 which is configured to receive a plurality of inputs 810 indicative of operating parameters of a powertrain system and evaluate the received inputs to determine and output a combustion classification 890.

In the illustrated example, the plurality of inputs 810 include crank angle 809, engine speed 811, exhaust pressure 813, hydrogen concentration 815, and ignition parameter 817. Crank angle 809 may be provided by or may be determined in response to output of a crank angle sensor and may be used as reference frame for the other inputs parameters provided to combustion classifier 820. Engine speed 811 may be provided by or may be determined in response to output of an engine speed sensor. Exhaust pressure 813 may be provided by or may be determined in response to output of a pressure sensor such as an exhaust manifold pressure (EMP) sensor. Hydrogen concentration 815, may be provided by or may be determined in response to output of a hydrogen sensor. Ignition parameter 817, may be provided by or may be determined in response to a measured voltage and may comprise, for example, a spark voltage, a make voltage, or a current or other electrical parameter indicative thereof or associated therewith.

Crank angle 809 and engine speed 811 are provided as inputs to engine speed classification operator 821 which is configured and operable to evaluate the received inputs and in response thereto determine and output an engine speed-based combustion classification indicating, for example, one of a normal combustion event, a misfire event, and a preignition combustion event. In determining and providing such output, engine classification operator 821 may evaluate a engine speed variations. In some embodiments, engine speed classification operator 821 may be configured as a lookup table (LUT) which correlates or maps a range of exhaust pressure values and a range of engine speeds with various combustion classifications (e.g., normal combustion, misfire, or preignition). Such an LUT may be empirically determined, for example, using techniques such as regression, correlation, and/or dependence analyses, and/or may be determined based on underlying physical principles. In some embodiments, engine speed classification operator 821 may perform one or more real-time calculations in addition to or instead of utilizing a LUT.

Crank angle 809 and exhaust pressure 813 are provided as inputs to exhaust pressure (EP) classification operator 822 which is configured and operable to evaluate the received inputs and in response thereto determine and output an EP-based combustion classification indicating, for example, one of a normal combustion event, a misfire event, and a preignition combustion event. In determining and providing such output, EP classification operator 822 may evaluate a pressure parameter, such as a peak pressure, and average pressure, pressure waveform or sampling thereof, pressure timing, pressure frequency, or other pressure parameters as will occur to one if skill in the art with the benefit and insight of the present disclosure. In some embodiments, EP classification operator 822 may be configured as a lookup table (LUT) which correlates or maps a range of exhaust pressure values and a range of engine speeds with various combustion classifications (e.g., normal combustion, misfire, or preignition). Such an LUT may be empirically determined, for example, using techniques such as regression, correlation, and/or dependence analyses, and/or may be determined based on underlying physical principles. In some embodiments, EP classification operator 822 may perform one or more real-time calculations in addition to or instead of utilizing a LUT.

Crank angle 809 and exhaust hydrogen concentration 815 are provided as inputs to hydrogen concentration ([H₂]) classification operator 824 which is configured and operable to evaluate the received inputs and in response thereto determine and output an [H₂]-based combustion classification indicating, for example, one of a normal combustion event, a misfire event, and a preignition combustion event. In some embodiments, [H₂] classification operator 824 may be configured as a lookup table (LUT) which correlates or maps a range of hydrogen concentration values and a range of engine speeds with various combustion classifications (e.g., normal combustion, misfire, or preignition). Such an LUT may be empirically determined, for example, using techniques such as regression, correlation, and/or dependence analyses, and/or may be determined based on underlying physical principles. In some embodiments, [H₂] classification operator 824 may perform one or more real-time calculations in addition to or instead of utilizing a LUT.

Crank angle 809 and exhaust ignition parameter 817 are provided as inputs to ignition classification operator 826 which is configured and operable to evaluate the received inputs and in response thereto determine and output an ignition parameter-based combustion classification indicating, for example, one of a normal combustion event, a misfire event, and a preignition combustion event. In some embodiments, ignition classification operator 826 may be configured as a lookup table (LUT) which correlates or maps a range of hydrogen concentration values and a range of engine speeds with various combustion classifications (e.g., normal combustion, misfire, or preignition). Such an LUT may be empirically determined, for example, using techniques such as regression, correlation, and/or dependence analyses, and/or may be determined based on underlying physical principles. In some embodiments, ignition classification operator 826 may perform one or more real-time calculations in addition to or instead of utilizing a LUT. In some embodiments, ignition classification operator 826 may utilize some or all of the techniques and operations described in connection with process 300.

The respective classifications determined and output by EP classification operator 822, [H₂] classification operator 824, and ignition classification operator 826 are provide as inputs to classification fusion operator 828 which is configured and operable to determine and output combustion classification 890. Classification fusion operator 828 may be configured with arbitration logic, averaging logic (including weighted averaging logic), if-then or rules based logic, prioritization logic, or other logic suitable for selecting from among or resolving differences between the inputs to classification fusion operator 828. In some embodiments, classification fusion operator 828 may be configured as a lookup table (LUT) which correlates or maps ranges of its received inputs with various combustion classifications (e.g., normal combustion, misfire, or preignition). Such an LUT may be empirically determined, for example, using techniques such as regression, correlation, and/or dependence analyses, and/or may be determined based on underlying physical principles. In some embodiments, classification fusion operator 828 may perform one or more real-time calculations in addition to or instead of utilizing a LUT.

Depending on the determination and output of classification fusion operator, classification 890 is set to or otherwise indicates one of multiple combustion classifications, for example, normal combustion, misfire, or preignition. Combustion classification 890 may be provided to and utilized by CC Responder 895 which may be configured to output in an alert, modify system operation, or both. In some embodiments CC Responder 895 modify operation of a spark-ignited hydrogen combustion engine, for example, by derating engine operation, entering a skip-fire engine operating mode, shutting off fuel for a particular cylinder, decreasing fueling for particular cylinder or a nearby cylinder to reduce heat generated by combustion, increasing a coolant flow rate, decreasing coolant temperature by operating one or more fans and/or heat exchangers, and/or other system operation modifications as will occur to one of skill in the art with the benefit and insight of the present disclosure.

It shall be appreciated that controls 800 may be configured in a number of variations relative to the illustrated example. In some embodiments, one of or both of exhaust pressure 813 and ignition parameter 817, and their respective associated control components may be omitted. In some embodiments, the plurality of inputs 810 may comprise additional or alternative inputs with associated control components generally corresponding to those associated with the illustrated ones of the plurality of inputs 810.

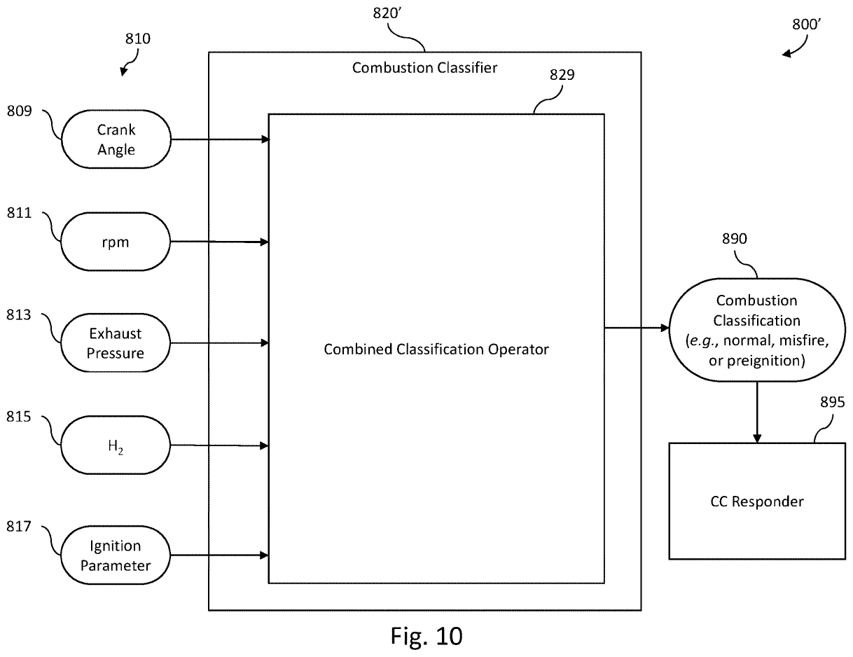

With reference to FIG. 10, there are illustrated example controls 800′ which may be implemented in and executed by an electronic control system (e.g., ECS 20 or another electronic control system), in operative communication with a powertrain system (e.g., system 11 or another powertrain system). Controls 800 may be implemented in and performed by one or more components of an electronic control system such as one or more electronic control units (e.g., ECU 22 and/or other electronic control units) and/or by other electronic control system components.

Controls 800′ include a number of features which are the same as or substantially similar to corresponding features of controls 800 which are denoted with the same reference numerals utilized in connection therewith. Controls 800′ include combustion classifier 820′ including combined classification operator 829 which is configured and operable to receive as inputs crank angle 809, engine speed 811, exhaust pressure 813, hydrogen concentration 815, and ignition parameter 817 and in response thereto determine and output combustion classification 890.

In some embodiments, combined classification operator 829 may be configured as a lookup table (LUT) which correlates or maps a range of exhaust pressure values and a range of engine speeds with various combustion classifications (e.g., normal combustion, misfire, or preignition). Such an LUT may be empirically determined, for example, using techniques such as multivariate regression, correlation, and/or dependence analyses, and/or may be determined based on underlying physical principles. In some embodiments, combined classification operator 829 may perform one or more real-time calculations in addition to or instead of utilizing a LUT.

It shall be appreciated that controls 800′ may be configured in a number of variations relative to the illustrated example. In some embodiments, one of or both of exhaust pressure 813 and ignition parameter 817, and their respective associated control components may be omitted. In some embodiments, the plurality of inputs 810 may comprise additional or alternative inputs with associated control components generally corresponding to those associated with the illustrated ones of the plurality of inputs 810.

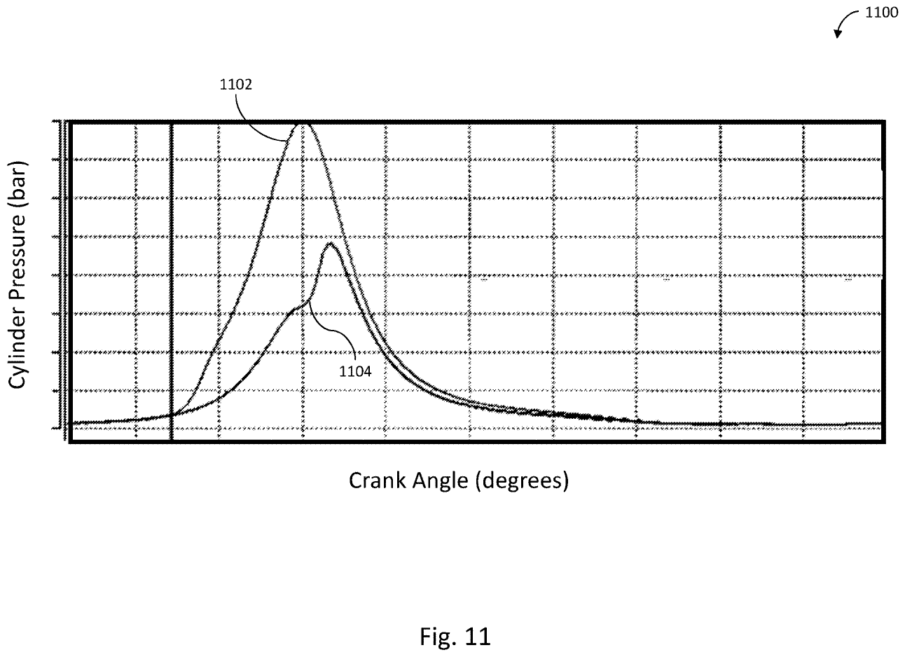

With reference to FIG. 11, there is illustrated a graph 1100 illustrating certain aspects of an example early preignition event in an example in-line six-cylinder engine configured to combust hydrogen. Graph 1100 depicts cylinder pressure curve 1102 for cylinder 6 of the engine and cylinder pressure curve 1104 for cylinder 5 of an the engine as a function of crank angle. Curve 1102 illustrates a normal combustion event for cylinder 6 of the engine. Curve 1104, illustrates an early preignition event for cylinder 5 of the engine which is out of phase with its intended crank angle and has a disrupted pressure profiled.

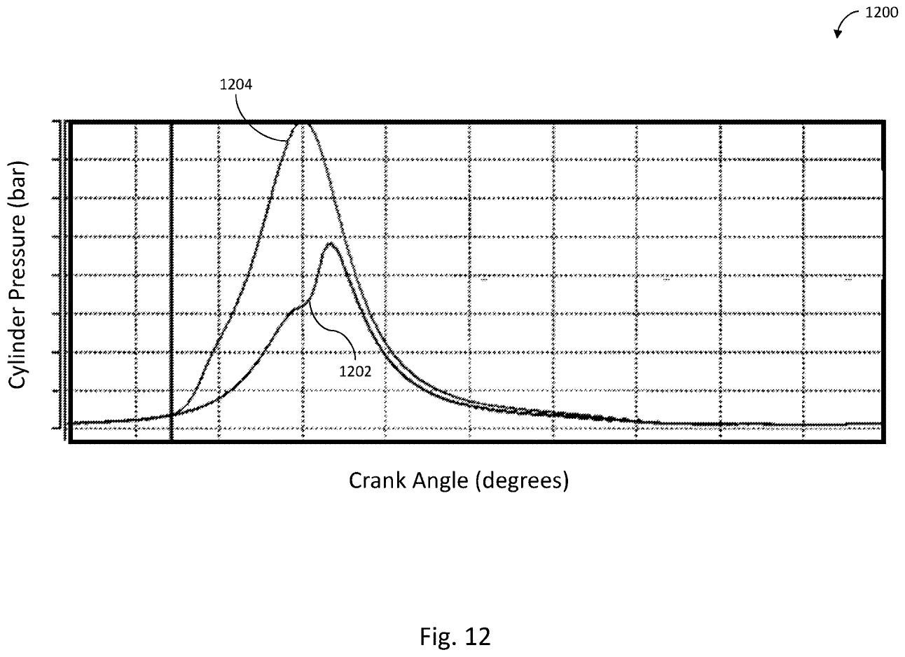

With reference to FIG. 12, there is illustrated a graph 1200 illustrating certain aspects of another example early preignition event of the example in-line six-cylinder engine of FIG. 11. Graph 1200 depicts cylinder pressure curve 1202 for cylinder 6 of the engine and cylinder pressure curve 1204 for cylinder 5 of the engine as a function of crank angle. Curve 1202 illustrates a normal combustion event for cylinder 5 of the engine. Curve 1204, illustrates an early preignition event for cylinder 6 of the engine which is out of phase with its intended crank angle and has a disrupted pressure profiled.

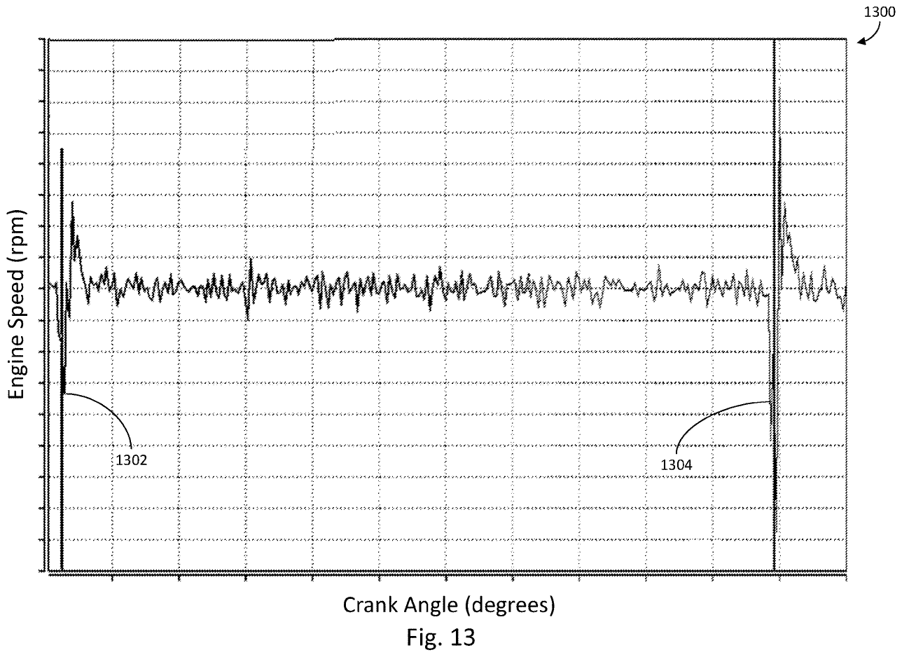

With reference to FIG. 13, there is illustrated a graph 1300 depicting an example effects on engine speed due to negative torque being generated during the early preignition events illustrated in graph 1100 if FIG. 11 and graph 1200 if FIG. 12. Curve portion 1302 illustrates an engine speed dip and spike associated with the preignition event of cylinder 5. Curve portion 1304 illustrates an engine speed dip and spike associated with the preignition event of cylinder 6.

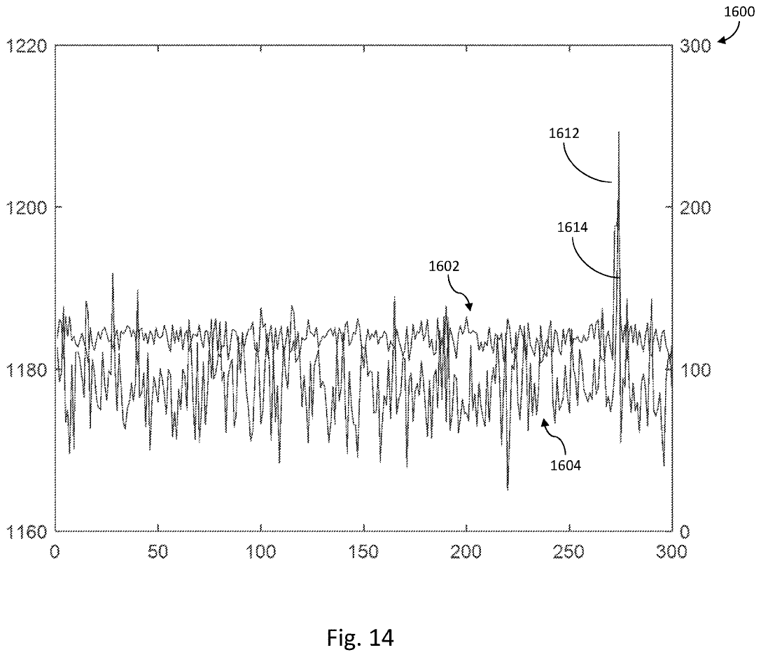

With reference to FIG. 14, there is illustrated a graph 1600 depicting a curve 1602 of area under exhaust manifold pressure (EMP) for cylinder 5 as a function of crank angle and a curve 1604 of area under EMP for peak cylinder pressure. Curve 1602 includes a spike 1612 between 250 and 300 degrees crank angle. Curve 1604 includes a spike 1614 between 250 and 300 degrees crank angle.

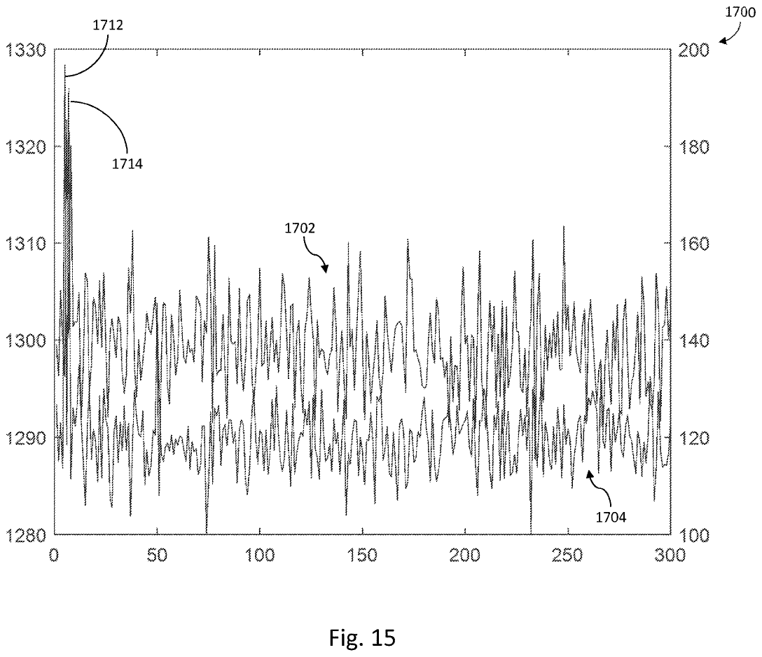

With reference to FIG. 15, there is illustrated a graph 1700 depicting a curve 1702 of area under exhaust manifold pressure (EMP) for cylinder 6 as a function of crank angle and a curve 1704 of area under EMP for peak cylinder pressure. Curve 1702 includes a spike 1712 shortly after 0 degrees crank angle. Curve 1704 includes a spike 1714 shortly after 0 degrees crank angle.

As shown by this detailed description, the present disclosure contemplates multiple and various embodiments, including, without limitation, the following example embodiments. A first example embodiment is a method of controlling a spark-ignited combustion engine to combust hydrogen, the method comprising: operating an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil; during the operating after controlling the switch to provide the primary current and before a spark has been generated by the spark plug, sensing a make voltage of the secondary circuit; diagnosing a preignition event based at least in part on the make voltage; and in response to the diagnosing at least one of modifying operation of the spark-ignited combustion engine and providing an operator perceptible output indicating the preignition event.

A second example embodiment includes the features of the first example embodiment, wherein the diagnosing the preignition event based at least in part on the make voltage comprises evaluating the make voltage relative to a threshold.

A third example embodiment includes the features of the first example embodiment, wherein the diagnosing the preignition event based at least in part on the make voltage comprises integrating the make voltage and evaluating a value resulting from the integrating.

A fourth example embodiment includes the features of the first example embodiment, wherein the diagnosing the preignition event based at least in part on the make voltage comprises diagnosing severity of the preignition based at least in part on the make voltage.

A fifth example embodiment includes the features of the first example embodiment, comprising during the operating after controlling the switch to provide the primary current and after a spark has been generated by the spark plug sensing a parameter indicative of a spark voltage; wherein the diagnosing the preignition event is further based on the parameter indicative of the spark voltage.

A sixth example embodiment includes the features of the fifth example embodiment, wherein the parameter indicative of the spark voltage comprises a spark duration.

A seventh example embodiment includes the features of the fifth example embodiment, wherein the diagnosing the preignition event comprises evaluating the parameter indicative of the spark voltage relative to a first threshold and evaluating whether the parameter indicative of the spark voltage is within a predetermined range of zero.

An eighth example embodiment includes the features of the seventh example embodiment, comprising diagnosing severity of the preignition based at least in part on the evaluating the parameter indicative of the spark voltage relative to the first threshold.

A ninth example embodiment includes the features of the seventh example embodiment, comprising diagnosing severity of the preignition based at least in part on the evaluating whether the parameter indicative of the spark voltage is within the predetermined range of zero.

A tenth example embodiment includes the features of the first example embodiment, wherein the diagnosing the preignition event based further based on an indication of knock from a knock sensor.

An eleventh example embodiment is a system adapted to control operation of a spark-ignited combustion engine to combust hydrogen, the system comprising: an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil; and an electronic control system configured to: control the switch to provide the primary current, after the switch is controlled and before a spark has been generated by the spark plug, sense a make voltage of the secondary circuit; diagnose a preignition event based at least in part on the make voltage; and in response to diagnosing a preignition event at least one of modifying operation of the spark-ignited combustion engine and providing an operator perceptible output indicating the preignition event.

A twelfth example embodiment includes the features of the eleventh example embodiment, wherein the electronic control system being configured to diagnose the preignition event based at least in part on the make voltage comprises the electronic control system being configured to evaluate the make voltage relative to a threshold.

A thirteenth example embodiment includes the features of the eleventh example embodiment, wherein the electronic control system being configured to diagnose the preignition event based at least in part on the make voltage comprises the electronic control system being configured to integrate the make voltage and evaluate a resulting integrated value.

A fourteenth example embodiment includes the features of the eleventh example embodiment, wherein the electronic control system being configured to diagnose the preignition event based at least in part on the make voltage comprises the electronic control system being configured to diagnose severity of the preignition based at least in part on the make voltage.

A fifteenth example embodiment includes the features of the eleventh example embodiment, wherein the electronic control system is configured to sense a parameter indicative of a spark voltage once a spark has been generated by the spark plug; wherein the diagnosing the preignition event is further based on the parameter indicative of the spark voltage.

A sixteenth example embodiment includes the features of the fifteenth example embodiment, wherein the parameter indicative of the spark voltage comprises a spark duration.

A seventeenth example embodiment includes the features of the fifteenth example embodiment, wherein the electronic control system being configured to diagnose the preignition event comprises the electronic control system being configured to evaluate the parameter indicative of the spark voltage relative to a first threshold and evaluate whether the parameter indicative of the spark voltage is within a predetermined range of zero.

An eighteenth example embodiment includes the features of the seventeenth example embodiment, wherein the electronic control system is configured to diagnose severity of the preignition based at least in part on the evaluating the parameter indicative of the spark voltage relative to the first threshold.

A nineteenth example embodiment includes the features of the seventeenth example embodiment, wherein the electronic control system is configured to diagnose severity of the preignition based at least in part on the evaluating whether the parameter indicative of the spark voltage is within the predetermined range of zero.

A twentieth example embodiment includes the features of the eleventh example embodiment, wherein the electronic control system is configured to diagnose the preignition event based further based on an indication of knock from a knock sensor.

A twenty-first example embodiment is a method of controlling a spark-ignited combustion engine to combust hydrogen, the method comprising: operating an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil; during the operating sensing a parameter indicative of a spark voltage; diagnosing a preignition event based at least in part on the parameter; and in response to the diagnosing at least one of modifying operation of the spark-ignited combustion engine and providing an operator perceptible output indicating the preignition event.

A twenty-second example embodiment includes the features of the twenty-first example embodiment, wherein the ignition system is an inductive ignition system and the parameter indicative of a spark voltage comprises a spark duration.

A twenty-third example embodiment includes the features of the twenty-first example embodiment, wherein the ignition system is a capacitive discharge ignition system and the parameter indicative of a spark voltage comprises a voltage at a node of the secondary circuit.

A twenty-fourth example embodiment includes the features of the twenty-first example embodiment, wherein the ignition system is an capacitive discharge ignition system and the parameter indicative of a spark voltage comprises a duration between a first time when a switch of the primary circuit is controlled to provide ignition and a second time when a predetermined change in a current in the secondary circuit is detected.

A twenty-fifth example embodiment includes the features of the twenty-fourth example embodiment, wherein the predetermined change in a current in the secondary circuit comprises a change in a current noise characteristic.

A twenty-sixth example embodiment includes the features of the twenty-first example embodiment, wherein the diagnosing the preignition event based further based on an indication of knock from a knock sensor.

A twenty-seventh example embodiment is a system adapted to control operation of a spark-ignited combustion engine to combust hydrogen, the system comprising: an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil; and an electronic control system configured to: control the switch to provide the primary current, after the switch is controlled sense a parameter indicative of a spark voltage; diagnose a preignition event based at least in part on the parameter; and in response to diagnosing a preignition event at least one of modifying operation of the spark-ignited combustion engine and providing an operator perceptible output indicating the preignition event.

A twenty-eighth example embodiment includes the features of the twenty-seventh example embodiment, wherein the ignition system is an inductive ignition system and the parameter indicative of a spark voltage comprises a spark duration.

A twenty-ninth example embodiment includes the features of the twenty-seventh example embodiment, wherein the ignition system is a capacitive discharge ignition system and the parameter indicative of a spark voltage comprises a voltage at a node of the secondary circuit.

A thirtieth example embodiment includes the features of the twenty-seventh example embodiment, wherein the ignition system is an capacitive discharge ignition system and the parameter indicative of a spark voltage comprises a duration between a first time when a switch of the primary circuit is controlled to provide ignition and a second time when a predetermined change in a current in the secondary circuit is detected.

A thirty-first example embodiment includes the features of the thirtieth example embodiment, wherein the predetermined change in a current in the secondary circuit comprises a change in a current noise characteristic.

A thirty-second example embodiment includes the features of the twenty-seventh example embodiment, wherein the electronic control system configured is configured to diagnose the preignition event based further based on an indication of knock from a knock sensor.

A thirty-third example embodiment is a method comprising: operating an internal combustion engine to combust hydrogen; during the operating sensing a hydrogen parameter indicative of hydrogen content of exhaust output by the internal combustion engine; diagnosing a preignition event of the internal combustion engine based at least in part on the hydrogen parameter; and in response to the diagnosing at least one of modifying operation of the internal combustion engine and providing an operator perceptible output indicating the preignition event.

A thirty-fourth example embodiment includes the features of the thirty-third example embodiment, comprising during the operating sensing a pressure parameter indicative of pressure of exhaust output by the internal combustion engine, wherein the diagnosing the preignition event is based at least in part on the pressure parameter.

A thirty-fifth example embodiment includes the features of the thirty-third example embodiment, comprising during the operating sensing an ignition parameter indicative of an ignition characteristic of exhaust output by the internal combustion engine, wherein the diagnosing the preignition event is based at least in part on the ignition parameter.

A thirty-sixth example embodiment includes the features of the thirty-fifth example embodiment, wherein the ignition characteristic comprises at least one of a spark voltage and a make voltage.

A thirty-seventh example embodiment includes the features of the thirty-third example embodiment, comprising during the operating sensing an engine speed parameter indicative of an engine speed of the internal combustion engine, wherein the diagnosing the preignition event is based at least in part on the engine speed parameter.

A thirty-eighth example embodiment includes the features of the thirty-seventh example embodiment, wherein the diagnosing is based at least in part upon one or more empirically determined lookup tables.

A thirty-ninth example embodiment includes the features of the thirty-seventh example embodiment, wherein the diagnosing comprises providing at least one of an exhaust pressure parameter, an ignition parameter, and an engine speed to the classification operator, and the classification operator is configured to output the combustion classification value in response to at least one of the exhaust pressure parameter and the ignition parameter.

A fortieth example embodiment is a system comprising: an internal combustion engine configured to combust hydrogen; an electronic control system operatively coupled with the internal combustion engine and configured to: operate the internal combustion engine to combust hydrogen; during operation of the internal engine to combust hydrogen, sense a hydrogen parameter indicative of hydrogen content of exhaust output by the internal combustion engine; diagnose a preignition event of the internal combustion engine based at least in part on the hydrogen parameter; and in response to diagnosis of the preignition event, at least one of modify operation of the internal combustion engine and provide an operator perceptible output indicating the preignition event.

A forty-first example embodiment includes the features of the fortieth example embodiment, wherein the electronic control system is configured to, during operation of the engine, sense a pressure parameter indicative of pressure of exhaust output by the internal combustion engine and diagnose the preignition event based at least in part on the pressure parameter.

A forty-second example embodiment includes the features of the fortieth example embodiment, wherein the electronic control system is configured to, during the operating, sense an ignition parameter indicative of an ignition characteristic of exhaust output by the internal combustion engine and diagnose the preignition event is based at least in part on the ignition parameter.

A forty-third example embodiment includes the features of the forty-second example embodiment, wherein the ignition characteristic comprises at least one of a spark voltage and a make voltage.

A forty-fourth example embodiment includes the features of the fortieth example embodiment, wherein the electronic control system is configured to, during the operating, sense an engine speed parameter of the internal combustion engine and diagnose the preignition event is based at least in part on the engine speed parameter.

A forty-fifth example embodiment includes the features of the forty-fourth example embodiment, wherein the electronic control system is configured to diagnose the preignition event is based at least in part upon one or more empirically determined lookup tables.

A forty-sixth example embodiment includes the features of the forty-fourth example embodiment, wherein the electronic control system being configured to diagnose the preignition event comprises the electronic control system being configured to provide at least one of an exhaust pressure parameter, an ignition parameter, and an engine speed to the classification operator, and the classification operator being configured to output the combustion classification value in response to at least one of the exhaust pressure parameter and the ignition parameter.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of controlling a spark-ignited combustion engine to combust hydrogen, the method comprising:
operating an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil;
during the operating after controlling the switch to provide the primary current and before a spark has been generated by the spark plug, sensing a make voltage of the secondary circuit;
diagnosing a preignition event based at least in part on the make voltage; and
in response to the diagnosing at least one of modifying operation of the spark-ignited combustion engine and providing an operator perceptible output indicating the preignition event.

2. The method of claim 1, wherein the diagnosing the preignition event based at least in part on the make voltage comprises evaluating the make voltage relative to a threshold.

3. The method of claim 1, wherein the diagnosing the preignition event based at least in part on the make voltage comprises integrating the make voltage and evaluating a value resulting from the integrating.

4. The method of claim 1, wherein the diagnosing the preignition event based at least in part on the make voltage comprises diagnosing severity of the preignition based at least in part on the make voltage.

5. The method of claim 1, comprising during the operating after controlling the switch to provide the primary current and after a spark has been generated by the spark plug sensing a parameter indicative of a spark voltage; wherein the diagnosing the preignition event is further based on the parameter indicative of the spark voltage.

6. The method of claim 5, wherein the parameter indicative of the spark voltage comprises a spark duration.

7. The method of claim 5, wherein the diagnosing the preignition event comprises evaluating the parameter indicative of the spark voltage relative to a first threshold and evaluating whether the parameter indicative of the spark voltage is within a predetermined range of zero.

8. The method of claim 7, comprising diagnosing severity of the preignition based at least in part on the evaluating the parameter indicative of the spark voltage relative to the first threshold.

9. The method of claim 7, comprising diagnosing severity of the preignition based at least in part on the evaluating whether the parameter indicative of the spark voltage is within the predetermined range of zero.

10. The method of claim 1, wherein the diagnosing the preignition event based further based on an indication of knock from a knock sensor.

11. A system adapted to control operation of a spark-ignited combustion engine to combust hydrogen, the system comprising:
an ignition system comprising a primary circuit comprising a first coil operatively coupled with a voltage source and a switch controllable to regulate a primary current through the primary circuit, a secondary circuit comprising a second coil operatively coupled with a spark plug, and a core magnetically coupling the first coil and the second coil; and
an electronic control system configured to:
control the switch to provide the primary current,
after the switch is controlled and before a spark has been generated by the spark plug, sense a make voltage of the secondary circuit;
diagnose a preignition event based at least in part on the make voltage; and
in response to diagnosing a preignition event at least one of modifying operation of the spark-ignited combustion engine and providing an operator perceptible output indicating the preignition event.

12. The system of claim 11, wherein the electronic control system being configured to diagnose the preignition event based at least in part on the make voltage comprises the electronic control system being configured to evaluate the make voltage relative to a threshold.

13. The system of claim 11, wherein the electronic control system being configured to diagnose the preignition event based at least in part on the make voltage comprises the electronic control system being configured to integrate the make voltage and evaluate a resulting integrated value.

14. The system of claim 11, wherein the electronic control system being configured to diagnose the preignition event based at least in part on the make voltage comprises the electronic control system being configured to diagnose severity of the preignition based at least in part on the make voltage.

15. The system of claim 11, wherein the electronic control system is configured to sense a parameter indicative of a spark voltage once a spark has been generated by the spark plug; wherein the diagnosing the preignition event is further based on the parameter indicative of the spark voltage.

16. The system of claim 15, wherein the parameter indicative of the spark voltage comprises a spark duration.

17. The system of claim 15, wherein the electronic control system being configured to diagnose the preignition event comprises the electronic control system being configured to evaluate the parameter indicative of the spark voltage relative to a first threshold and evaluate whether the parameter indicative of the spark voltage is within a predetermined range of zero.

18. The system of claim 17, wherein the electronic control system is configured to diagnose severity of the preignition based at least in part on the evaluating the parameter indicative of the spark voltage relative to the first threshold.

19. The system of claim 17, wherein the electronic control system is configured to diagnose severity of the preignition based at least in part on the evaluating whether the parameter indicative of the spark voltage is within the predetermined range of zero.

20. The system of claim 11 wherein the electronic control system is configured to diagnose the preignition event based further based on an indication of knock from a knock sensor.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
